(19) United States
(12) Patent Application Publication
(10) Pub. No.: US 2010/0185588 A1
(43) Pub. Date: Jul. 22, 2010

(54) SYSTEM AND METHODS FOR STORING ABSTRACT DATA IN MULTI DIMENSIONAL VECTORS

(76) Inventor: Vladimir Grigorian, Alpharetta, GA (US)

Correspondence Address: Vladimir Grigorian, 440 Welbury Ct., Alpharetta, GA, 30005, US

(21) Appl. No.: 12/355,790

(22) Filed: Jan. 18, 2009

(51) Int. Cl. G06F 17/30; G06F 7/00

(52) U.S. Cl. 707/661

(57) ABSTRACT

The system and methods described below pertain to advanced database architectures for storing complex data structures that can be used by various applications. The architecture allows multiple data elements to be assigned a unique coordinate on an axis within a dimension. A relation of data elements as a tuple of their coordinates forms a single point in multi-dimensional space, which is stored in a binary file as an abstract representation of complex data structures allowing accelerated and direct data access.

### BACKGROUND OF THE INVENTION

1. Field of the Invention

This invention relates to storing data in digital formats, specifically to database architecture.

2. Description of Related Art

All modern applications contain a database. A database is an electronic filing system. Its main function is to store and retrieve information organized in such a way that a computer program can quickly select desired data components. The majority of database management systems are hierarchical, network, relational, object and associative. The dominant model in use today is relational, although a given database management system may provide one or more of the five models.

All of these systems inherit drawbacks of relational databases described below. These drawbacks cause slow performance, limited scalability and high maintenance costs for users.

### Basic Description of Current Technologies (Relational Databases)

Relational databases store data in tables. A table is a two-dimensional set of values that is organized using a model of vertical columns and horizontal rows. A table is the simple term for relation. A table has a pre-defined number of columns and can have any number of rows. The columns are identified by name, and the rows are identified by the values appearing in a particular column subset, which has been identified as a primary key. These primary keys can be used as foreign keys in another table—more than once per table. For example, a simple database may contain 5 tables—Sales, Products, Stores, Suppliers and Customers. A Sales table may contain a foreign key column PRODUCT_ID pointing to primary key column in Products table, while Products might be referencing Suppliers, and so on.

### Drawbacks of Relational Databases

a. Inability to Access Data Directly

Relational databases sequentially scan columns and rows, instead of accessing atomic data elements directly.

Lets consider horizontal data access first—by columns. If a table has 50 columns and a user is querying a value in column 48, a relational database will have to scan the first 47 columns first. However, this matter is further complicated when it comes to vertical data access—by rows. Regardless of whether or not a relational database performs index or table scan, the process is still a scan. If this table contains 10,000 rows, this may not be a problem. However, most large companies have decades worth of data on millions of orders or thousands of employees. Lets consider a conservative example of a 10 billion row table containing a single value. If it takes 10 milliseconds to retrieve a value and 3 hours to find it (sequentially scan the table), the amount of wasted time is 99.99991%. Although indexes help, the extent of improvement may not be significant, if at all present. In some cases indexes actually worsen database performance, especially while inserting and updating data. The sequential access is like looking for needle in haystack. There are technologies that assist in getting to the needle faster (partitioning, correct joining order and other approaches). They point to approximate location within the stack.

However, this will only shorten needle-searching time from days to hours.

b. Using Foreign Key to Reference Data

Relational databases use considerable numbers of artificial foreign keys to reference minimal amounts of user data.

In addition to storing data in two-dimensional tables, relational model reflects data affinity by using primary and foreign keys. The foreign key identifies a column or a set of columns in one (referencing) table that refers to a column or set of columns in another (referenced) table. The columns in the referenced table must form a primary key. The values in one row of the referencing columns must occur in a single row in the referenced table. In certain types of complex transactions such as sales orders, it is not unusual to find foreign keys in more than half the columns. For example, if a simple sales database contains 4 tables with 14 columns total, 6 of these columns might be foreign keys. These 6 columns serve no purpose other than connecting data in remaining 8 columns.

This artificial way to connect data consumes considerable amounts of space and computational resources. Almost all activities in complex databases are executed via primary/foreign key access. Let's take a look at another example. An actual data warehouse for a large convenience store company keeps track of what has been sold and where. The most frequently sold items in such stores are usually gasoline and beer. The data is kept for up to five years and later archived. A simple fact table will contain 36 billion rows. Suppose we use indexing and aggregation to answer a simple question: “How many times did we sell gasoline and beer over the past 5 years?” We will have to scan through 1.2 billion foreign key rows several times over. But this relational query only counts occurrence of a single row PRODUCT_TYPE_ID. It returns primary key 24322 (for Gas) and 20754 (for Beer). It does not even scan trough the actual row PRODUCT_TYPE_NAME. Incidentally, this is another drawback of relational model because names “Gas” and “Beer” happen to be shorter than their primary keys repeatedly stored in more than half of the 36 billion SALES rows. This implies that although user values “Beer” and “Gas” only occupy 7 bytes in the database, their foreign keys take up more than 7 Gigabytes, a billion times difference. It takes up to several hours for this query to return results because of the amount of artificial primary/foreign keys. This relational database stored and retrieved the same product type id information over and over again, a billion times over in this case, even though we only needed it once for “Beer” and once for “Gas”, as in case of this particular query. How much time and effort was spent productively? The answer is about 0.00000083%.

c. Sequential Execution of Multiple Tasks on Unknown Data

This refers to relational databases inability to process multiple unknown data in parallel. People can perform multiple computational tasks on the same unknown data simultaneously, unlike relational databases. For example, a question: “What would a talking bird enjoy eating?” can be answered with a “cracker” or whatever a parrot likes eating. A human can answer both questions “Which bird talks?” and the resulting “What do parrots like to snack on?” at the same time. The complexity of questions in case of humans is almost linear to speed. This means that an average person will spend almost the same amount of time coming up with an answer either for the parrot/cracker question, or a much more complicated query with 5-6 unknowns. Relational databases are not so linear. In RDBMS world, the above mentioned query will first select from a hypothetical table ANIMALS all creatures that can talk and are happen to be birds (you will get an ANIMAL ID of 345, which is meaningless in terms of answering the question “What does a talking bird like eating?”). Only then a relational database will scan a second table FEEDING and find the value “Crackers” in the column HABITS corresponding to the ANIMAL_ID 345 the relational database returned in the first task. Relational databases perform multiple unknown tasks one after another. With RDBMS, we cannot get the “Crackers” unless we have already retrieved the “345” from a previous task. Although this may not be a prominent issue for an online transaction processing system, the consequences are disastrous for batch databases. A simple multi-step batch job takes days, instead of minutes.

d. Due to Model Limitations, Relational Databases can't Operate with Abstract Data, Wastefully Composing and Decomposing its Low Level Attributes at Run Time.

Relational databases waste computational resources by repeatedly putting low level data components together, presenting them to the user and actually making an effort to discard them from memory, over and over again.

Humans operate with abstract ideas or tasks. We usually learn of an abstraction (for example, how to walk to an office) only once. If you ask someone for directions to office, you are given specific verbal instructions: “straight down the hall, turn left, then right and it is on your left”. You follow the instructions once and then they are stored in your brain as a single abstract task in some context. The term “context” is useful here because the same abstract concept can exist in different contexts (work office as opposed to the one at your home). The second time you need to use an office, this abstraction does not have to be verbalized or constructed from its individual properties in order to be used. One just gets up and goes, and that is all there is to it. The low level properties of this abstract task remain in long-term memory, unrealized. However, if somebody—a new employee, perhaps—asks you for the same directions, you will readily provide the same verbal instructions (abstractions' low level properties) you were given yourself some time ago. Unlike humans, relational databases can't operate with abstract data, working only with low level data components connected by primary and foreign keys. These components are put together at run time to create or update a representation of complex information as it exists in real world. In order to answer simple questions like “what products were purchased in order 12945, and at what store”, users have to scan many indexes and tables (ORDERS, PRODUCTS, STORES, etc.). Table ORDERS will have an actual order # 12945, but will point to STORES and PRODUCTS for translation of meaningless STORE_ID and PRODUCT_ID (73455 and 76545, for example). This complex task may contain hundreds of steps, take a minute, but only involves single abstract entity “products in order 12945”. Now imagine 1,000 users executing similar queries or updates with different variables—simultaneously. All of this time and effort is wasted putting the same abstractions together, presenting them to the users or applications and actually making an effort to discard them from memory. This happens repeatedly, time after time, millions of occurrences a day.

e. Relational Databases are not Portable

In the relational world, identical data in two databases may be incompatible: a purchase order in one database may have different foreign and primary key values and columns in a different order from an order in another database. Relational column and table names (as well as data types and primary/foreign keys values) are hard coded into custom applications. For example, one pharmaceutical database may store Aspirin under primary key #123456. Another database may store Cyanide under the same DRUG_ID.

Each time an application is built, the programmer has to build a new set of tables. This task is time consuming, complex and expensive, even though there might be a few bytes' difference between the old and forthcoming application code. You have to understand the data and the structure of the database to write anything other than the simplest program accessing data within a relational database.

If a database designer decides to describe an item (a column in a table) by giving it attributes of its own, the entire relational database will have to be restructured. This requires replacing column with values with a foreign key column and adding a new relation. Imagine doing this for a 10,000 table application, each table with its own column names, data types and lengths, constraints, etc.

f. Excessive Metadata Overhead

Relational databases need a large amount of internal tables to maintain just a few user tables Metadata (data about relational data, the foreign and primary keys, not actual user data) in most cases consumes more space and resources than user data it maintains. These system tables keep track of relations, columns, rows, partitions, etc. There are 1,643 default metadata tables in Oracle 10g R2 containing not less than 2,474,601 rows. The 2 million rows number applies to the most commonly used Enterprise Edition of Oracle. Moreover, metadata tables are being constantly analyzed and updated by Oracle behind the scenes. Now, suppose you created a single user table with two rows in it. How useful is this ratio—2 million metadata rows to maintain only 2 rows you will ever use?

g. Redundant Data

Relational databases tend to store large amounts of redundant data. Although relational model provides options for using unique constraints, these options are rarely used for majority of user columns such as FIRST_NAME, LAST_NAME, CITY, etc. As a result a typical employee table ends up filled with 20%-30% of identical first or last names, up to 60% of the same city names, etc.

A database management system that solves these and other shortcomings of relational databases will allow faster performance, higher scalability and lower maintenance costs.

### DESCRIPTION OF THE INVENTION

### SUMMARY OF THE INVENTION

The system and methods described below pertain to advanced database architectures for storing complex data structures that can be used by various applications. The architecture allows multiple data elements to be assigned a unique coordinate on an axis within a dimension. A relation of data elements as a tuple of their coordinates forms a single point in multi-dimensional space, which is stored in a binary file as an abstract representation of a complex data structure.

### BRIEF DESCRIPTION OF THE DRAWINGS

Without restricting the full scope of this invention, the preferred form of this invention is illustrated in the following drawings:

FIG. 1 shows an example of vector V1 with a unique vector run length, which is stored in vector database as an intersection of values “Milk” on Product axis, “061229090103” on Transaction axis, and “6” on Stores axis.

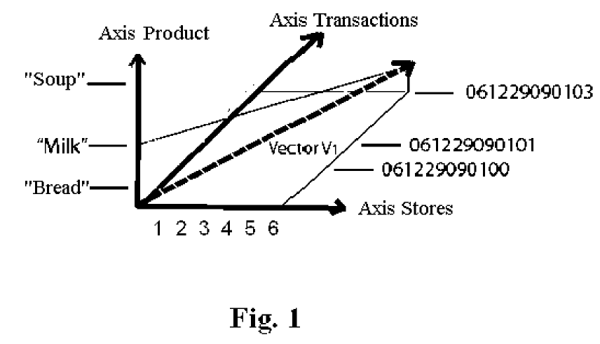

FIG. 2. shows timing of vector database running a query on the same amount of data as market leader in only 0.000189 seconds instead of 2.3 seconds, more than a thousand times performance improvement.

FIG. 3 shows sequence of tasks for creating of a vector database.

FIG. 4. depicts sequence of tasks for querying a vector database.

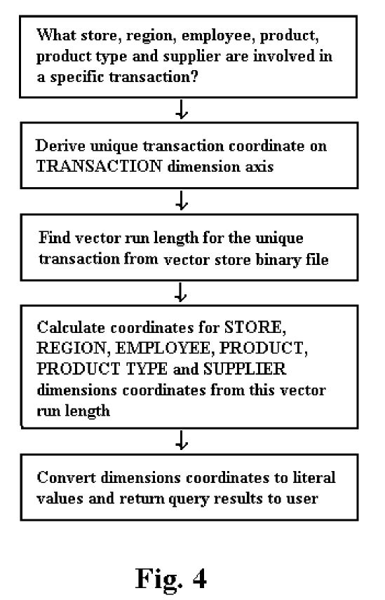

FIG. 5. illustrates an example of empty 8 numbers long 3D vector store.

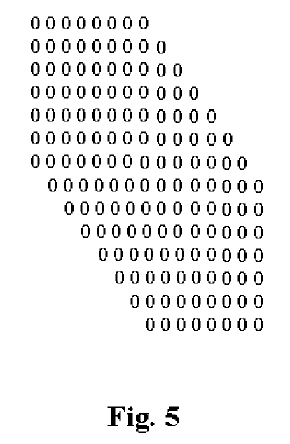

FIG. 6. shows how a vector will increment on axis x.

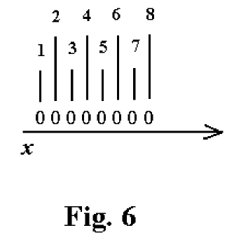

FIG. 7. shows how example vector increments and wraps into from dimension x into dimension y in a 3 dimensional vector store.

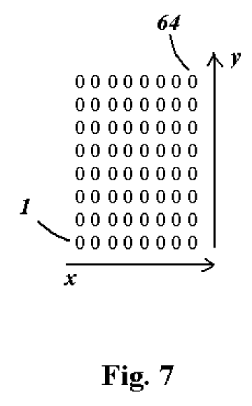

FIG. 8. shows an empty 3D vector store with 2D vector space wrapping up into 3D at 64 and filling up entire vector store at 512.

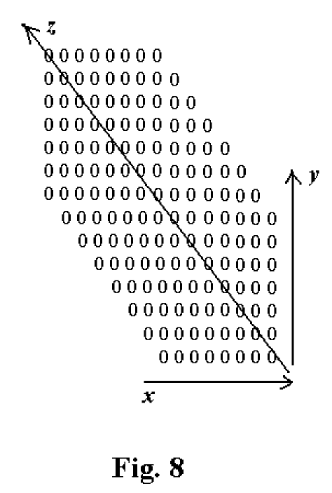

FIG. 9. shows representation of a 3 dimensional vector database consisting of three indexes and one vector store, wherein index 12 stores values for dimension 13, order of which within the index represents its dimension coordinate; index 14 stores user entries for dimension 15 and index 16 stores values for dimension 17.

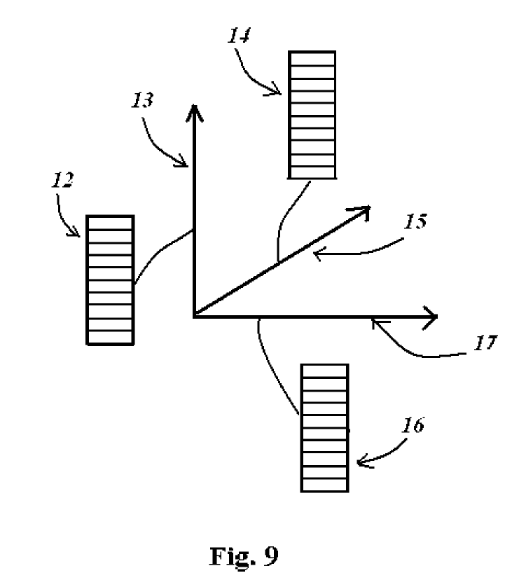

### DETAILED DESCRIPTION

Before describing vector database technology, it is important to clarify that term “vector database” may be used in connection with vector indexing of web pages, vector sequencing in molecular biology, vector representation of geographical data or other technologies. These approaches are fundamentally different because they use conventional database (including relational systems) to store physical vector components (such as lengths, angles, directions) in tables, while vector database described herein uses math formulae to compute which bits should be set to either “0” or “1” in a binary file called vector store. Although vector algebra is used to calculate affinity of user data stored in indexes called dimensions, vectors per se do not exist in vector database. In other words, vector database is an alternative to relational databases which conventional vectoring technology use to store vector descriptions. In addition there are data warehouse database systems using dimensional modeling by storing data in so-called dimension tables.

These, however, are still relational databases with all their shortcomings outlined above. Dimensions in a relational database are logical entities representing the same relational tables. The main factors to distinguish vector database from these systems are the following: vector database uses already pre-joined abstract data as it exists in nature, accesses vector database does not store data in tables, does not use primary and foreign keys, vector database can access data directly instead of sequentially scanning tables and indexes, can process multiple unknown data components at the same time and does not store redundant data or NULL values. More details on vector database differences outlined below.

The following description is demonstrative in nature and is not intended to limit the scope of the invention or its application of uses.

The invention applies to a database management system called vector database, which joins multiple low level data components into single abstract entity. Using vector database allows significantly faster performance, higher scalability and lower maintenance costs because it solves major shortcomings of relational and object databases described above.

To explain the concept of vector database, lets consider an analogy. Suppose, a person were given a sheet of paper with a hundred lines of numbers, two numbers in a row:

1,2
45,34
23,4,
etc.

The person is asked to draw points on another sheet of paper with two intersecting orthogonal coordinate axes—vertical and horizontal. The person ends up with 100 points representing 200 items. For example 1,2 will be represented by a dot intersecting at coordinate 2 on vertical axis (y) and coordinate 1 on horizontal axis (x). The person then discards of paper #1 because he can recreate low level data (any of two coordinates on any of the hundred lines) from paper #2, the one with the dots and two axes.

Essentially, vector database is the sheet paper #2. It converts literal data to numbers and stores them as vectors, each in a single bit of information. Now imagine billions of lines represented by dots, instead of only a hundred; imagine hundreds of dimensions instead of two per line and you will have an understanding how VDBMS operates. Nothing is actually drawn, of course—there are software components that use complex math formulas to derive vector values and store them in vector store which is nothing more than a binary file containing “On” and “off” values.

### Performance Benchmark Against Leading Relational Database

To conduct a fair performance test against the leading relational database vendor, we create TRANSACTIONS, STORE, REGION, EMPLOYEES, PRODUCT, PRODUCT_TYPE and SUPPLIER tables and appropriate indexes in RDBMS, and identically named dimensions in VDBMS prototype software. Both databases populated with the same content. Both run on the same computer, one at a time. Indexes were created in the relational database to speed up query performance. Then we run the same query in both databases.

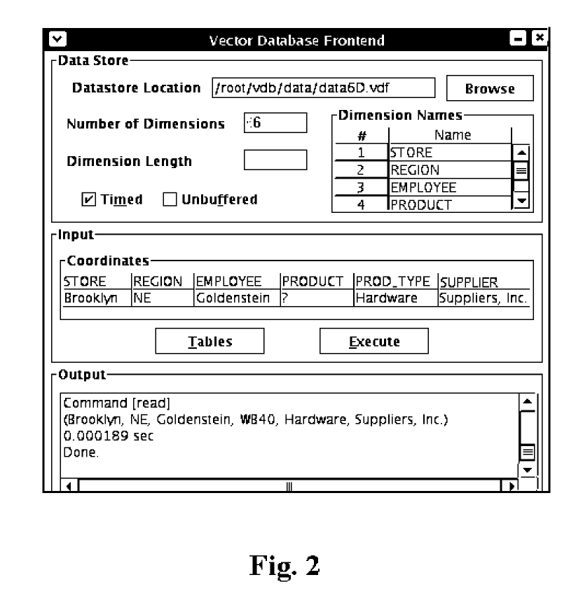

In relational database the query takes 2.03 seconds, while in vector database it runs only 0.000189 seconds, a thousand times performance improvement as shown in FIG. 2.

Such a tremendous difference in database performance can be easily explained by number and duration of tasks executed by each database to derive the same results. The relational database executes 13 steps on 7 tables and 4 indexes in 2.3 seconds. Out of these 13 steps, 6 are foreign and primary key index scans.

Vector database, on the other hand, executes only 5 steps in 0.000189 seconds. It accesses only one structure, not 7 (as in RDBMS). It also does not scan table primary or foreign keys, which do not exist in VDBMS. The entire query calculates vector end point in 7 dimensional spaces, projects it onto dimension axes and returns query results to the user.

### Physical Database Structures

Relational databases store data in tables. A table may have several columns containing user data (TRANSACTION_DATE, TOTAL_AMOUNT, etc.) primary keys (TRANSACTION_ID) and foreign keys (EMPLOYEE_ID, STORE_ID, etc.) pointing to another table's primary keys. In addition, relational databases might have indexes to speed up query.

Vector database is fundamentally different by design. It has only two physical structures: dimension indexes (one or more) and a sorted vector store. Both entities are accessed directly (meaning that no sequential scanning is involved) and in parallel, i.e. by multiple processes at the same time. Such essential relational database entities as primary keys, foreign keys or tables do not exist in a vector database.

### User Interaction with Vector Database

Generally, vector database stores data in the following order. Users specify one or more values to be stored in a database as an abstract entity. The software places the values into indexes without any foreign or primary keys. The order of each value in a specific index represents its dimension coordinate.

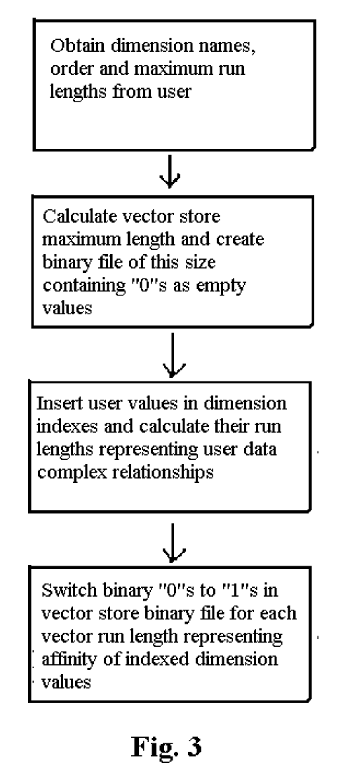

As shown in FIG. 3, the next step is calculation of vector run length for the abstract entity in a multi-dimensional vector space. The resulting vector run length is a number that can be de-composed to any or all dimension values entered by users. This vector run length is then stored in a vector store by switching a specific bit in a binary file from “Off” to “On” value. The location of this bit from beginning of the binary file is equal to vector run length. There could be billions of vectors in one vector store binary file.

For example, the administrator creates a database (called SALES, for example). The vector database administrator creates 3 dimensions and places them in database data dictionary under a specific name, order and maximum length. For instance, every abstract entity in this database is characterized by a car part, shop and city. The database administrator creates dimensions CAR_PARTS, SHOP, and CITY.

Let's consider the CAR_PARTS dimension. All entries in this dimension are specific to car part names—tire, engine, gear box, etc. Each entry is stored in a specific order. The order within an index dimension identifies location of this entry on dimension axis. For example, engine is entry number 2 from beginning of the index. This means engine has a coordinate of 2 on axis CAR_PARTS. All other coordinates on different dimensions intersecting with this coordinate in multi-dimensional space have a common property—they are all related to engine.

Dimension CITY, in turn, has ordered entries as well—Bombay, Calcutta, Delhi. Delhi was inserted into this dimension index after Calcutta. Calcutta was inserted after Bombay, which was the first entry. Delhi, therefore, has a coordinate of 3 on the CITY dimension.

All CAR_PARTS intersecting with 3 on CITY dimension represent parts available in Delhi. The same principle applies to SHOP dimension—it has coordinates intersecting with two other coordinates in a 3D space, each representing a unique part available in a specific shop in some city.

### Vector Database Math Engine

This part of the document describes the inner workings of the software in general.

A vector store is a binary file consisting of one continuous string of “Off” and “On” values, described herein as 0s and 1s. The string contains multiple vectors; they are not stored individually.

It has a fixed length and preset number of dimensions (both can be infinite in theory). A 0 correspond to no value (an “Off” value), 1—to an entry (an “On” value). Each 1 in this n-dimensional space represents some vector end. The length of vector store string is constrained by maximum number of values stored in a dimension and also by number of dimensions.

Here is an example of vector store:

| | |
|---|---|
| Number of dimensions: | 7 |
| Maximum length of each dimension: | 20 |
| Maximum number length of entire vector store: | 20 \hat{ } 7 = 1,280,000,000 |

Note: A dimension can store Lₘₐₓ−1 long numbers because last number wraps into a higher order dimension (see below for explanation). For example, maximum number in an 8 increments long vector store is 7, not 8.

### Creating Vector

When dimension has reached its maximum length, a vector run length is continuously wrapped into a new dimension. These dimensions are positioned in a f fixed order across a vector's length. A particular vector's run length continues until it reaches its own end (vector end point, signified by a 1), or entire vector store's length limit.

To manipulate these vectors we simply move their vector end points in multi-dimensional space without deriving or changing individual dimension axis coordinates from indexes. FIG. 12 shows an example of an empty 8 number long 3D vector store.

### Example of Empty Vector Store

Let's consider a simple vector store with 3 dimensions, each being 8 numbers long. Creation of a 3D vector store entry
1) First, the vector stores increments on axis x from left to right until it reaches current dimension maximum length of 8.
2) Next, it wraps by 1 on next dimension y, starts again at x=0 and y=1 and continues on dimension x until both dimensions are filled at 8̂2=64 increments.
3) After the first two vectors store dimensions are occupied, the remaining third dimension is used in similar fashion—z in this 3D example. Every increment on dimension z is a vector run length increase by 64. Since maximum length of all dimensions is 8, z will wrap up 8 times maximum, making total vector store length 512.

### Examples of Occupied 3D Vector Store

Occupied vector store contains one or more 1 (“On” values), each representing a unique vector. Each vector, in turn, represents one or more dimension coordinates it is composed of

Here is a continuous 3D vector run length with vector signified by 1 at length 282 shown in bold italics:

++++++++++++++++++++++
00000000000000010010100001000100001000000000000000000000000000000000
00000000000000000000000000000000000000000000000000000000000000000000
00000000000000000000000000000000000000000000000000000000000000000000
00000000000000000000000000000000000000000000000000000000000000000000
0000000000000000000 [symbol] 001000000000000000000000000000000000000000000000
00000000000000000000000000000000000000000000000000000000000000000000
0000000
++++++++++++++++++++++

The actual vector store will contain only “On” vector run lengths:

++++++++++++++++++++++

[symbol]

++++++++++++++++++++++

Let's store a single vector ending at intersection of 2 on axis x, 3 on y and 4 on z, constituting vector with run length 282.

Total vector store length: 512
Vector run length: 282

| Dimension | User Value | Dimension | Max |
|---|---|---|---|
| Name | (Coordinate) | Order | Length |
| X | 2 | 1 | 8 |
| Y | 3 | 2 | 8 |
| Z | 4 | 3 | 8 |

First, we start with the highest dimension order out of dimensions list—dimension z. We get z coordinate—a user entered value—from the vector specifications above, which is 4.

This means that vector store has to wrap up 4 times on first two dimensions x and y (8×8×4=256), then vertically increment by 3 on axis y—next down from the highest dimension order (8×3=24). We then add the lowest dimension order value, dimension x, which increments vector run length horizontally by 2. So we add 2 to 280 (256+24),

assigning a vector end location (vector run length) of 282 in vector store. This means if this particular vector store has an “On” (or 1) at run length 282, the user entered values of 2 for x, 3 for y and 4 for z. In general, vector run length can be translated back to all and any axis coordinates (even with multiple unknowns) using dimension order and their maximum length. Regardless of how many billions of vectors are stored in this vector store, all axis coordinates can be derived directly from one value—vector run length. This takes place because vector end point can be logically positioned (computed) against axis dimensions in computer memory due to:
a) Vector store having fixed number of dimensions, each dimension wrapping into a lower order dimension at a predetermined calculated length.
b) This last nD wrap up length being exponentially larger than next lower order dimensions.
c) Dimensions having fixed length and order within a vector store.

To continue further, let's define some terms used herein

Definitions

| Name | Definition | Symbol |
|---|---|---|
| Vector run | Unique number of | V |
| length | consecutive 0s and 1s in | |
| | nD space ending in | |
| | particular vector end | |
| | point. One vector store | |
| | can have none, one or | |
| | more vector run lengths. | |
| Dimension | Maximum number of 0s | Lₘₐₓ |
| length | or 1s a dimension can | |
| | store. Dimensions have a | |
| | fixed length (different or | |
| | identical as compared | |
| | with other dimensions), | |
| Maximum | Maximum number of | n |
| number of | dimensions per vector | |
| dimensions | store, for 3D this | |
| | number will be 3 | |
| Last nD wrap up | A fixed number of 0s or 1s vector run length has to exceed to generate an nD matrix. First and second dimensions are excluded. Multiple per vector. | 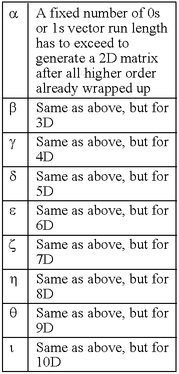 |

### Calculation of Vector Run Length (End Point Location in Vector String)

To calculate (or alter) vector run length, we have to remember that it wraps from higher order dimension to lower ones precisely at user entered dimension value until it reaches its lowest order dimension, which has a final value of x. This continues until entire vector store limit has been reached.

For 10D vector run length is equal to:

V=X+α+β+γ+δ+ε+ζ+η+θ+ι

Therefore, for 3D vector run length is:

V=X+α+β

More specifically, 3D vector run length V₃ is:

((Lₘₐₓ)^{n-⊥})*Z+(Lₘₐₓ*Y)+X

This, however, does not imply that we need to know values of Z or Y to get X. They can be derived independently, as shown below.

### Querying Vector Run Length (Singe Value)

FIG. 11 depicts a vector database query.

1. Deriving Z from Vector Run Length

To derive value of Z from 3D vector run length V₃:

$$Z = ⌊ \frac{{V}_{3}}{{( {L}_{max} )}^{n - 1}} ⌋$$

### EXAMPLE 1

X=2, y=3, z=4

Before we derive Z axis coordinate, let's calculate vector run length:

((Lₘₐₓ)^{n-⊥})*Z+(Lₘₐₓ*Y)+X=(8̂2)*4+8*3+2=256+24+2=282

Now we can calculate the z from vector length of 282.

$$Z = ⌊ \frac{{V}_{3}}{{( {L}_{max} )}^{n - 1}} ⌋ = Floor ( 282 / 8 \hat{} 2 ) = Floor ( 4.40625 ) = 4$$

### EXAMPLE 2

X=2, y=3, z=7
Vector run length=474

$$Z = ⌊ \frac{{V}_{3}}{{( {L}_{max} )}^{n - 1}} ⌋ = Floor ( 474 / 8 \hat{} 2 ) = Floor ( 7.40625 ) = 7$$

2. Deriving Y from Vector Run Length

To derive y from 3D vector run length:

$$Y = ⌊ \frac{V - {( {L}_{max} )}^{n - 1} * Z}{{L}_{max}} ⌋$$

### EXAMPLE 1

X=2, y=3, z=4
Vector length=282

$$\begin{matrix}Y = ⌊ \frac{V - {( {L}_{max} )}^{n - 1} * Z}{{L}_{max}} ⌋ \\ = Floor ( ( 282 - ( 8 \hat{} 2 * 4 ) ) / 8 ) \\ = Floor ( ( 282 - 256 ) / 8 ) \\ = Floor ( 3.25 ) \\ = 3\end{matrix}$$

### EXAMPLE 2

X=6, y=7, z=5
Vector length=382

$$\begin{matrix}Y = ⌊ \frac{V - {( {L}_{max} )}^{n - 1} * Z}{{L}_{max}} ⌋ \\ = Floor ( ( 382 - ( 8 \hat{} 2 * 5 ) ) / 8 ) \\ = Floor ( 7.75 ) \\ = 7\end{matrix}$$

### 3. Deriving X

To derive x from 3D vector run length we simply subtract all higher order dimension wrap up numbers:

X=(Lₘₐₓ)^{n-⊥}*Z+(Lₘₐₓ*Y)

### EXAMPLE 1

X=2, y=3, z=4
Vector length=282

X=(Lₘₐₓ)^{n-⊥}*Z+(Lₘₐₓ*Y)=282−256−24=2

### EXAMPLE 2

X=6, y=7, z=8
Vector length=574

X=(Lₘₐₓ)^{n-⊥}*Z+(Lₘₐₓ*Y)=574−512−56=6

### Querying Vector Range Scan (Multiple Values from Multiple Vectors) in 3D

Querying multiple vectors for data sets answers questions like “what stores carry arugula?” or “what items where sold between 9 AM and 2 PM”? These queries return multiple values and may scan entire vector store.

Before we calculate data sets from vector store, lets convert 09 and 14 (9 AM and 2 PM) to dimension coordinates 8492 and 8587 by querying dimension tables.

For highest order dimensions this question is answered the following way:

$${Z}_{s} = \{ ( {L}_{max}^{n - 1} * 8492 ) > V > ( {L}_{max}^{n - 1} * 8587 ) \}$$

For lowest order dimensions this is accomplished by:

$${X}_{s} \{ 8492 > ( V - ( α + β ) ) > 8587 \} = \{ 8492 > ( V - ( ⌊ \frac{V}{{L}_{max}^{n - 1}} ⌋ * {L}_{max}^{n - 1} ++ ⌊ \frac{V - ⌊ \frac{V}{{L}_{max}^{n - 1}} ⌋ * {L}_{max}^{n - 1}}{{L}_{max}} ⌋ * {L}_{max}^{n - 1} ) ) > 8587 \}$$

For dimension Y we can use the following formula:

$${Y}_{s} = \{ 8492 > ⌊ \frac{V - ⌊ \frac{V}{{L}_{max}^{n - 1}} ⌋ * {L}_{max}^{n - 1}}{{L}_{max}} ⌋ > 8587 \}$$

### EXAMPLE 1

Existing vector run lengths=282, 382, 474, 574 (vector run lengths satisfying the query are marked in bold)

Vector store:

+++++++++++++++++++++++++++
00000000000000000000000000000000000000000000000000000000000000000000
00000000000000000000000000000000000000000000000000000000000000000000
00000000000000000000000000000000000000000000000000000000000000000000
00000000000000000000000000000000000000000000000000000000000000000000
00000000100000000000000000000000000000000000000000000000000000000000
00000000000000000000000000000000000000001000000000000000000000000000
00000000000000000000000000000000000000000000000000000000000000000100
00000000000000000000000000000000000000000000000000000000000000000000
0000000000000000000000000000010
+++++++++++++++++++++++++++

Or actual vector run lengths stored (vector run lengths satisfying the query are marked in bold):

+++++++++++++++++++++++++++

[symbol]

382

[symbol]

574
+++++++++++++++++++++++++++

Query: find vectors with y=3
Using formulae above, lets calculate y values for each V:

Floor(282−(Floor(282/8̂2))*8̂2))/8=Floor((282−4*64)/8)=Floor (3.25)=3

Floor(382−(Floor(382/8̂2))*8̂2))/8=Floor((382−5*64)/8)=Floor (7.75)=7

Floor(474−(Floor(474/8̂2))*8̂2))/8=Floor((474−7*64)/8)=Floor (3.25)=3

Floor(574−(Floor(574/8̂2))*8̂2))/8=Floor((574−8*64)/8)=Floor (7.75)=7

Our query returned vectors ending with a 1 at 282 and 474, ruling out 382 and 574. Incidentally, this query first calculated values of z before values of y without scanning any other entities.

### Vector Store for 4+ Dimensions

Vector database is not constrained by only 3 dimensions. It can store multiple vectors in infinite numbers of dimensions, each vector end representing an infinite amount of information. This will be impossible to demonstrate and comprehend in 3D, but in math terms it is not as difficult. All we have to remember is that the fourth dimension is all space that one can get to by traveling in a direction perpendicular to three-dimensional space. The same principle applies to higher dimensions. Let's consider an example of a 4D vector. This vector run length is equal to the added lengths of all four dimension values. These dimensions wrap into next lower order dimension when they reach their run length limit (fill up). Deriving values of higher order dimensions from vector run length is fairly easy because they are exponentially larger then their lower dimension run lengths. So, for 4D vector with a 4ₜₕ dimension coordinate of 4 and 4ₜₕ dimension wrap up length of gamma:

V=α+β+X+γ

Or

V₄=Lₘₐₓⁿ⁻²*D+Lₘₐₓ^{n-⊥}*Z+Lₘₐₓ*Y+X

This computation is applicable to higher order dimensions—5, 6, 7, 8, 9, 10 and so on. Let's derive 4ₜₕ dimension coordinates.

### EXAMPLE 1

X=2, Y=3, Z=7, Zn=5—where Zn is the fourth dimension length
Vector length=2560+474=3034 (we just added 4D value of 2560 (8̂3*5) to a 3D Vector run length of 474 created by x=2, y=3, z=7 in example above)
Zn=Floor (V/Lmax̂n−1)=Floor (3034/8̂4−1)=Floor (5.92578125)=5

### EXAMPLE 2

X=2, Y=3, Z=4, Zn=8—where Zn is the fourth dimension length
Vector length=4096+282=4378 (we just added 4D value of 4096 (8̂3*8) to a 3D vector run length of 282 created by x=2, y=3, z=4 in example above)
Zn=Floor (V/Lmax̂n−1)=Floor (4378/8̂4−1)=Floor (8.55078125)=8
Example of User Interaction with a Hypothetical Vector Database

Let's consider a 3-dimensional vector database with Lₘₐₓ=8 containing the following data:

### Dimension 1, CAR_PARTS

### Value 1: Tire

### Value 2: Engine

### Value 3: Gear box

### Dimension 2, CITY

### Value 1: Bombay

### Value 2: Calcutta

### Value 3: Delhi

### Dimension 3, SHOP

### Value 1: Venus Traders

### Value 2: Reliance Traders

### Value 3: McMillian & Sons

### Querying Vector Database

Locating data is simple. Value i in the table of dimension j corresponds to the ith element in the dimension. To calculate their intersecting point in vector store we use formula:

runlength=(Z−1)*Lₘₐₓ²+(Y−1)*Lₘₐₓ+(X−1)+1

The above formula is for 3D vector store. This can be extended to a larger number of dimensions as follows:

runlength=1+Σ[(Zᵢ−1)*Lₘₐₓⁱ⁻¹] for i=1 to n

Suppose we add two vectors: (Tire, Delhi, Reliance Traders) and (Tire, Bombay, Venus Traders). The vector run lengths for these two vectors will be computed as follows:

### EXAMPLE 1

### (Tire, Delhi, Reliance Traders)=(1, 3, 2)

Run length=1×8̂2+2×8+0+1=81

### EXAMPLE 2

### (Tire, Bombay, Venus Traders)=(1, 1, 1)

Run length=0×8̂2+0×8+0+1=1

To check if Reliance Traders sell tires in Delhi, we run in vector database prototype UNIX prompt:

### $ Read Tire Delhi “Reliance Traders”

This will be executed in accordance to the following algorithm:

1. Find the location of Tire in dimension 1 (CAR_PARTS)
Result: The location/order of Tire in dimension 1 is 1, i.e. X=1 (see data description above).
2. Find the location of Delhi in dimension 2 (CITY)
Result: The location of Delhi in dimension 2 is 3, i.e. Y=3.
3. Find the location of reliance Traders in dimension 3 (SHOP)
Result: The location of Reliance Traders in dimension 3 is 2, i.e. Z=2.
4. Fetch the value stored at location X=1, Y=3 and Z=2 from vector store. This will be executed as follows:
a) The O-based location of the vector, denoted by X=1, Y=3 and Z=2, in bits, is computed using the formula:

(Z−1)×Lmax̂2+(Y−1)×Lmax+(X−1)=1×8̂2+2×8+0=80

Note: This is the same as run length −1.
b) This can be converted to bytes using the following set of formulae:
1) O-based bit number 80 in the data store contains the desired value.
2) In order to access this bit we must first read the byte containing this bit and then extract this bit from that byte.
3) A byte contains 8 bits.
4) If we divide the location in bits by 8, the quotient of the division gives us the byte number whereas the remainder gives us the bit number within that byte. Using this fact, we get:

Byte number=Floor(80/8)=10

Bit number=80 mod 8=0

i.e bit number 0 of byte number 10 (which is, in fact 1ₛₜ bit of the
11ₜₕ byte in a 1-based system) contains the desired value.
5) Suppose the index occupies Lₙ bytes.
6) Then, the actual position of the desired bit in the file would be the bit number 0 of byte number (Ln+10).
c) Read the value of the bit number 0 of byte number (Ln+10) in the file.
5. Return this value to the user.

### Inserting into Vector Database

Add the vector “Venus Traders sell gear boxes in Bombay” to the database.

In vector database UNIX prompt we type:

### $ Write “Gear Box” Bombay “Venus Traders”

This will be executed in accordance with the following algorithm:

1) Find the location of Gear Box in dimension 1 (CAR_PARTS)
Result: The location of Gear Box in dimension 1 is 3 (see description above), i.e. X=3.
2) Find the location of Bombay in dimension 2 (CITY)
Result: The location of Bombay in dimension 2 is 1, i.e. Y=1.
3) Find the location of Venus Traders in dimension 3 (SHOP)
Result: The location of Venus Traders in dimension 3 is 1, i.e. Z=1.
4) Turn the bit at location X=3, Y=1 and Z=1 in the vector store.
This will be executed as follows:
a) The O-based location of the vector, denoted by X=3, Y=1, Z=1, in bits is computed using the formula:

(Z−1)×L_{max̂}2+(Y−1)×Lₘₐₓ+(X−1)=0×8̂2+0×8+2=2

This is the same as run length −1.
b) This can be converted to bytes using the following formulae:
1) O-based bit number 2 in the data store is the desired bit.
2) In order to modify this bit we mi must first read the byte containing this bit, set this bit in that byte and then write this byte back at the same location.
3) A byte contains 8 bits.
4) If we divide the location in bits by 8, the quotient of the division gives us the byte number whereas the remainder gives us the bit number within that byte. Using this fact, we get:

Byte number=Floor(2/8)=0

Bit number=2 mod 8=0

5) Suppose the index tables occupy Ln bytes.
6) Then, the actual position of the desired bit in the file would be the bit number 2 of the byte number (Ln+0).
c) Read the value of byte (Ln+0) in the file.
d) Turn bit number 2 of this byte on.
e) Write the new value at location (Ln+0) in the file.
6. Inform the user that the value has been written to the database.

### Performing Range Scan of Vector Database

Finding all shops in Delhi that sell Tire can be achieved by using the query:

### $ Read Tire Delhi ?

The “?” signifies all values with these two properties—Delhi and Tire.
This will be done in accordance with the following algorithm:
1. Find the location of Tire in dimension 1 (CAR_PARTS)
Result: The location of Gear Box in dimension 1 is 1 (see description above), i.e. X=1.
2. Find the location of Delhi in dimension 2 (CITY)
Result: The location of Delhi in dimension 2 is 3, i.e. Y=3.
3. Find all vectors with X=1 and Y=3.
Result: Let's say the vector (1, 3, 1) and (1, 3, 3) were found.
4. Translate the Z coordinates of the first vectors to words:
a) The Z coordinate of the first vector (1, 3, 1) corresponds to Venus Traders in dimension 3 (SHOPS).
b) The Z coordinate of the second vector (1, 3, 3) corresponds to McMillian & Sons in dimension 3 (SHOPS).
5. The returned results would be, therefore (Tire, Delhi, Venus Traders) and (Tire, Delhi, McMillion & Sons).

### Future Improvements

These enhancements may be incompatible with each other, i.e. the implementation of one makes another one obsolete, inefficient or unnecessary.

### 1. Reserving Unique Dimension Coordinate as the Highest Order Dimension

Usually a vector store will contain a unique dimension, which will identify its atomic values. In relational databases this would be equivalent to ROWID or column like TRANSACTION_ID or SOCIAL_SECURITY_NUMBER. Since this dimension will contain most values in a vector database, it should be automatically created as the highest order dimension. Dimensions with lower number of values (Lₘₐₓ) such as US_REGION or SEX_MF should be created as the lowest order dimension. This will allow substantially smaller binary vector store sizes.

### 2. Linking Multiple Vector Stores by Using Reflected Dimensions

For complex databases consisting of thousands of variable length dimensions it will be feasible to link vector stores by unique dimensions. This is completely different from using primary and foreign key because none of these entities will be used in vector database, only the order of unique dimension index entries is reflected.

For example, a 6D vector store TRANSACTIONS having a unique TRANSACTION_ID dimension. Another vector store TRANSACTION_TIME_SERIES will have daily, weekly, monthly and yearly roll ups linked by TRANSACTION_ID. The second vector store will not have to store these dimension values because they already exist in TRANSACTIONS. However, their values will be calculated in both vector stores run lengths.

Another example: vector store TRANSACTIONS

### DIM 1: TRANSACTIONS

### DIM 2: PRODUCTS

### DIM 3: STORES

### DIM 4: EMPLOYEES

### DIM 5: SUPPLIERS

### DIM 6. SUPPLIER_INDUSTRY_CODE

### DIM 7: SUPPLIER_ADDRESS

### DIM 8: SUPPLIER_REGIONS

Let's say the highest vector run length in this case will be 99999999999 and will occupy 1 TB. If we separate suppliers into a different vector store we don't have to calculate 3 supplier-related dimensions in this TRANSACTIONS vector store (SUPPLIER_INDUSTRY_CODE, SUPPLIER_ADDRESS and SUPPLIER_REGIONS), only the SUPPLIERS_FK which will point to order of unique SUPPLIER_NAME dimension in a separate vector store SUPPLIERS, which in turn might be linked to vector store REGIONS.

This way TRANSACTIONS max run length will be something like 99999, because it is 3 dimensions shorter and max size will be 10 GB, not 1 TB (granted, there will be an additional 40 MG SUPPLIERS vector store).

3. Loading Contents of Lower Order Dimensions into Memory

For frequently used lower order dimensions, such as REGIONS or SEX_MF it will be useful to load them into computer memory on vector database program startup so they don't have to be read from disk.

This will allow faster query response for all vector stores containing this dimension because some of the data will be already cached in RAM.

### 4. Use of Filtered Indexes

Filtered indexes can point to groups of vectors characterized by certain qualities. For example, on vector store can have index DX_TRANSACTIONS_{—}00001_TO_{—}00999, then additional index IDX_TRANSACTIONS_{—}01000_TO_{—}09999, etc. The same vector store will have indexes on other dimensions, such as IDX_EMPLOYEES_{—}0001_TO_{—}0999 and so on. This will allow partial vector scan and will result in faster query response for certain queries.

### 5. Use of Composite and Function Based Indexes

Composite index means index on more than one dimension (TRANSACTIONS and STORES, for example). In this case user query will make only one trip to disk or cache for both values. The same applies to combining a dimension coordinate with a literal value it represents. For example, IDX_SUPPLIERS will have an entry for dimension coordinate 231 and actual supplier name UNIVAC in the same index entry. This way only one entry will be read instead of 2.

Function based index is an index with entries already changed by a function, so full vector store scan is avoided. These are used for queries that used such functions as truncate, upper/lower, to_date, etc.

### 6. Parallel Vector Store Scan

For operations involving range or full vector store scans it is possible to enable parallel scanning. For example, if a scan involves more than 100 MB of data, the load is divided into 4 partitioned workloads of 25 MB. The workloads are scanned simultaneously by several CPU processes and results are returned to vector math engine. The number of partitioned operations will depend on the amount of data to be scanned and number of available CPUs.

### 7. Pre-Aggregation

Performance can be further improved by pre-aggregating the most frequently used query results. This implies to pre-calculating certain query results ahead of time, storing them on disk and providing their results to the user upon request.

### 8. Compression

Vector stores contain numbers. This makes them excellent candidates for compression. For example, if a vector store is less than half occupied, only “On” values are stored. If it is more than half occupied, only “Off” values are stored. This will cause less data to be stored on disk.

9. Initializing Vector Store with Pointers to Empty Sectors

A vector store with a million possible vector end points may actually store only one vector. To speed up store initialization, vector store can be divided into multiple sectors, each having a pointer to memory (header). This pointer will notify if any of sectors are empty, so that they may be can be skipped during full or range vector store scans.

### 10. Auto Extending Vector Store at 80% Full

In case maximum dimension length is reached, vector store will be automatically extended when 80% of vector store occupied. Dimension run lengths recalculated automatically as well.

### 11. Using Automated Sorting of Dimension Indexes

In order to speed up query performance, it may be beneficial to periodically re-arrange dimension indexes to make them sorted after new entries insertion and re-calculate vector run lengths for related vectors, at least for larger dimension indexes, such as TRANSACTION_ID. This will result in faster performance because index is sorted.

### SUMMARY

From the description above, a number of advantages of system and methods for storing abstract data in multi dimensional vectors become evident:
a) The system operates without basic components of prior art such as tables, primary and foreign keys, resulting in a performance improvement of more than 1,000 times.
b) The system allows direct data access in both entities in consists of: dimension indexes and sorted binary file called vector store, which is impossible in current database software.
c) The system allows simultaneous operations on multiple unknown data components, which is impossible in current database technologies.
d) The system operates with pre-joined abstract data as required by user query, instead of putting low level information together at run time.
e) The system requires very limited metadata overhead because of absence of tables, primary and foreign keys.
f) The system is much easier to operate and port to other systems because of its simplicity and focus on user needs.
g) The system stores no redundant or NULL data, causing less computational resources and space consumption and faster performance.

I claim:

1. A system for storing and retrieving data comprising multiple dimensions, each containing an axis with a coordinate, each said coordinate representing data discrete, independent existence, and intersections of said coordinates forming points and resulting vectors stored on disk in a binary file, each said vector representing unique and abstract data relationship.

2. The system of claim 1, wherein a number of dimension indexes each having a specific order within a database.

3. The system of claim 1, wherein each user data element is stored in said dimension index having a unique coordinate identified by its order in said index.

4. The system of claim 1, wherein data elements' unique coordinates are passed to a calculation engine which computes single vector end points in multidimensional space, where said intersection represents complex data relationship.

5. The system of claim 1, wherein each vector end point assigned a unique vector run length representing number of empty bits in multi-dimensional space running in a specific order ending in said vector end point.

6. A system for storing abstract data, comprising a binary file containing “On” and “Off” values wherein each “On” value represents an existing vector run length being equal to its location within said binary file.

7. The system of claim 6, wherein binary file “On” values are added, deleted and updated to reflect changes to relationship between multiple user data elements stored in dimension indexes.

8. The system of claim 1, wherein users query dimension coordinates from indexes, passed them to calculation engine to calculate vector run length and determine whether specific bits within binary file are “On” or “Off.”.

9. The system of claim 1, wherein one or more vector run lengths of specific “On” values in a binary file are passed to a calculation engine which computes individual dimension coordinates, derives their literal values from dimension indexes and returns query results to users.

10. The system of claim 1, wherein most frequently used vectors are copied and stored in a memory buffer for faster access.
